(19) United States
(12) Patent Application Publication
(10) Pub. No.: US 2020/0177047 A1
(43) Pub. Date: Jun. 4, 2020

(54) POWER TOOL

(71) Applicant: MAKITA CORPORATION, Anjo-shi (JP)

(72) Inventor: Yuta KUTSUNA, Anjo-shi (JP)

(21) Appl. No.: 16/598,529

(22) Filed: Oct. 10, 2019

(30) Foreign Application Priority Data
Nov. 29, 2018 (JP) 2018-223985

(51) Int. Cl. H02K 3/52; H02K 3/38; H02K 7/14; H02K 11/215; H02K 11/30; H02K 11/00; H02K 21/16; B25F 5/02

(52) U.S. Cl. CPC H02K 3/522; H02K 3/38; H02K 7/145; H02K 11/215; H02K 11/30; B25B 21/00; H02K 21/16; B25F 5/02; H02K 2203/06; H02K 2211/03; H02K 11/0094

(57) ABSTRACT

A power tool, such as an angle screwdriver (1), includes a motor (4) having a rotor (22) that rotates relative to a stator (21). The stator (21) includes a tubular stator core (23), rear and front insulators (24, 25) fixed to the stator core (23), coils (26) wound through the rear and front insulators (24, 25) and on the stator core (23), and fusing terminals (32) respectively connected to the coils (26). Terminal fittings (34A-34C) are physically connected to a polymer-based terminal unit (33) and electrically connected to the fusing terminals (32). Power supply lines (83) are respectively connected to the fusing terminals (32). The terminal fittings (34A-34C) are disposed entirely radially inward of an outer diameter of the stator core (23) when viewed in an axial direction of the stator core (23).

### CROSS-REFERENCE

The present application claims priority to Japanese patent application serial number 2018-223985 filed on Nov. 29, 2018, the contents of which are incorporated fully herein by reference.

### TECHNICAL FIELD

The present invention generally relates to power tools having an electric motor, such as an angle screwdriver.

### BACKGROUND ART

US 2018/0241281 A1 and DE 10 2018 103 644 A1 disclose a power tool, in which a stator of a motor is housed inside a housing, and is electrically connected to a controller by lead wires (power supply lines). More particularly, fusing terminals are fused to a wire of coils, and are latched to a connector, which radially protrudes from an insulator. The lead wires connected to the controller and corresponding to the fusing terminals are soldered to a terminal unit, which is screw fastened and thereby joined to the connector. Owing to the use of this terminal unit, separation of the stator and the controller from one another becomes possible, thereby making the power tool easy to assemble and repair.

### SUMMARY OF THE INVENTION

However, in the above-described known power tool, because the terminal unit is assembled in a manner such that it juts radially outward from the stator, and because the lead wires are drawn (extend) radially outwardly, the portion of the terminal unit that juts out partially protrudes from the housing that houses the stator, thereby requiring a correspondingly wide housing to accommodate the terminal unit and motor.

Accordingly, it is one non-limiting object of the present invention to provide a power tool in which the housing that houses the stator can be made more compact in a radial direction of the motor.

In one aspect of the present disclosure, a power tool (such as an angle screwdriver) includes:

a stator comprising a tubular stator core, an insulator fixed to the stator core, a coil wound through the insulator and on the stator core, and a coil terminal connected to the coil;

a rotor, which is capable of rotating relative to the stator;

a lead wire terminal provided integrally with a resin (polymer) member and connected to the coil terminal;

a lead wire connected to the lead wire terminal;

wherein the lead wire terminal is disposed on an inner side (radially inward) of an outer diameter of the stator core when viewed from (in) an axial direction of the stator core.

Optionally, the lead wire terminal may be connected to the coil terminal by a screw.

In addition or in the alternative, the coil terminal may be held by the insulator, a connecting part with the lead wire terminal may extend in the axial direction of the stator core, and the coil terminal may be disposed on the inner side (radially inward) of the outer diameter of the stator core when viewed from (in) the axial direction of the stator core.

Optionally, the coil terminal and the lead wire terminal may overlap in a radial direction of the stator and may be screw fastened together.

In any of the above-noted aspects, the resin member may be formed in an endless shape.

In another aspect of the present disclosure, a power tool (such as an angle screwdriver) includes:

a stator comprising a tubular stator core, an insulator fixed to the stator core, a coil wound through the insulator and on the stator core, and a coil terminal connected to the coil;

a rotor, which is capable of rotating relative to the stator;

a power supply line, which is directly or indirectly connected to the coil terminal;

a sensor circuit board, which is fixed to the insulator; and

a signal line, which is connected to the sensor circuit board;

wherein the power supply line and the signal line are drawn out (extend) in the same direction as the axial direction of the stator.

Additional objects, aspects, embodiments and advantages of the present teachings will become apparent upon reading the following detailed description in view of the appended drawings and claims.

### BRIEF DESCRIPTION OF THE DRAWINGS

FIG. 1 is a center, longitudinal, cross-sectional view of a rechargeable angle screwdriver according to one non-limiting embodiment of the present disclosure.

FIG. 2 is an enlarged view of a portion of a brushless motor according to FIG. 1.

FIG. 3 is an oblique view of a stator of the brushless motor.

FIG. 4 is an exploded oblique view of the stator.

FIG. 5 is an exploded oblique view of the stator on which a sensor circuit board has been mounted.

FIG. 6 is a longitudinal cross-sectional view of the stator.

FIG. 7 is an oblique view of a stator according to a modified embodiment of the present teachings.

### DETAILED DESCRIPTION OF THE EMBODIMENTS

Embodiments of the present disclosure are explained below, with reference to the drawings.

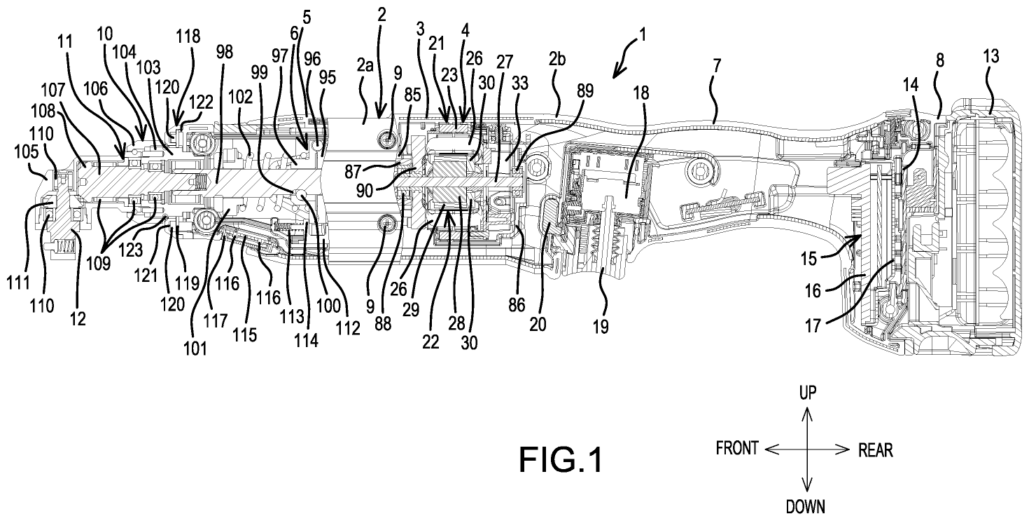

FIG. 1 is a center, longitudinal, cross-sectional view of a rechargeable angle screwdriver (hereinbelow, simply called a “screwdriver”) 1, which is one representative example of a power tool according to the present disclosure.

### Explanation of the Overall Configuration of the Screwdriver

A main-body part (housing) 2 of the screwdriver 1 comprises: a motor housing 3, which is a tubular body that extends in a straight line in a front-rear direction and houses a brushless motor 4 at the center in the front-rear direction; a clutch housing 5, which is coupled to (adjoins) a front side of the motor housing 3, houses a clutch 6, and extends forward; a grip housing 7, which is coupled to (adjoins) a rear side of the motor housing 3 and extends rearward; and a battery-mount part 8, which is coupled to (adjoins) a rear side of the grip housing 7. The main-body part 2 is formed by assembling (joining) left and right half housings 2a, 2b together using screws 9.

A front-side housing 10 houses an output part 11, extends forward, and has the shape of an L turned on its side in side view. The front-side housing 10 is coupled to (adjoins) a front end of the main-body part 2. An output shaft 12 protrudes downward.

On the other end of the screwdriver 1, a battery pack 13, which constitutes a power supply, is configured to be mounted, by being slid from below, onto the battery-mount part 8. A terminal block 14 is electrically connected to the mounted battery pack 13 and is provided inside the battery-mount part 8. A controller 15 is provided on the front side of and parallel to the terminal block 14. The controller 15 includes a control circuit board 16 disposed within a case 17. A capacitor, a microcontroller (e.g., a microprocessor and memory), a switching device, and the like are mounted on the control circuit board 16.

Forward of the terminal block 14, a trigger switch 18, from which a trigger 19 protrudes downward, is housed in a front-side portion of the grip housing 7. A forward/reverse-changing button 20 of the brushless motor 4 is provided forward of the trigger switch 18.

Explanation of the Brushless Motor

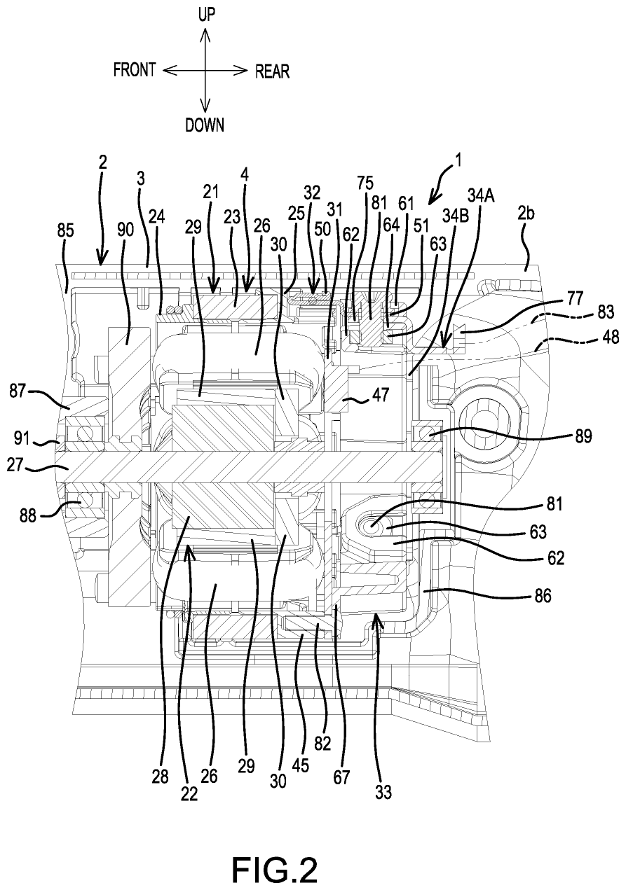

The brushless motor 4 is an inner-rotor type motor that comprises a tube-shaped stator 21 and a rotor 22, which passes through the stator 21. As shown also in FIG. 2, the stator 21 comprises: a stator core 23; a front insulator 24 and a rear insulator 25, which are provided forward and rearward of the stator core 23; and coils 26, which form a three-phase winding by being wound through the front and rear insulators 24, 25 and on the stator core 23. The rotor 22 comprises: a rotary shaft 27, which is located at the axial center of the rotor 22; a tube-shaped rotor core 28, which is disposed around the rotary shaft 27; permanent magnets 29, which are disposed on (around) the outer side of the rotor core 28 and whose polarities alternate in the circumferential direction; and permanent magnets 30 for sensing the rotational position of the rotor 21, which magnets 30 are disposed radially on the rear side of the permanent magnets 29.

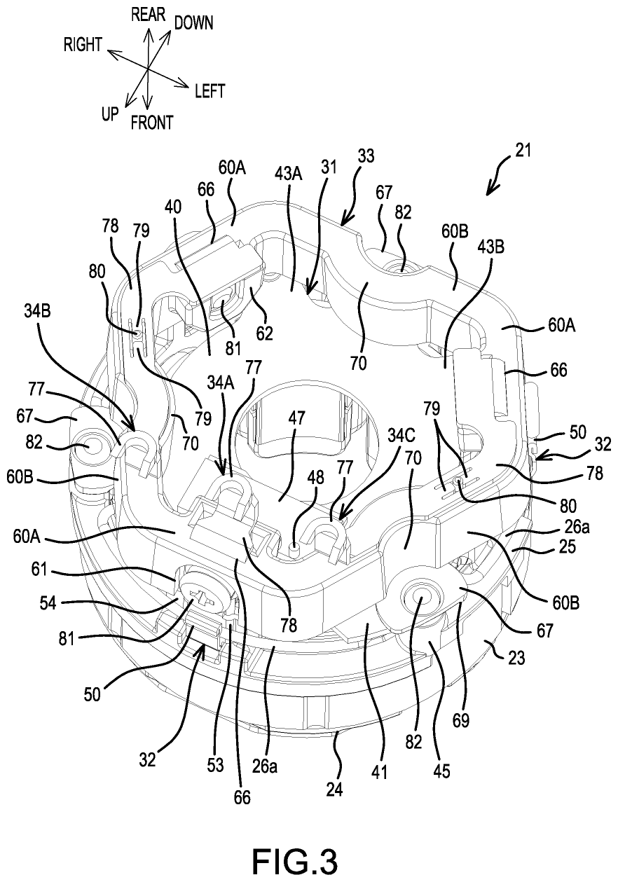

In addition, as shown also in FIG. 3, the following structures are mounted on the rear end (side) of the rear insulator 25: a sensor circuit board 31, which detects the locations of the permanent magnets 30 and on which are mounted rotation-detection devices (not shown) that output rotation-detection signals; three fusing terminals 32, which serve as coil terminals that are fused to a magnet (coil-energizing) wire 26a, one for each phase, that is electrically connected to the coils 26; and a terminal unit 33 comprising (physically holding/retaining) three terminal fittings 34A-34C, which serve as lead wire terminals for respectively connecting the three-phase power supply lines (lead wires) to the fusing terminals 32. These structures are explained below in order.

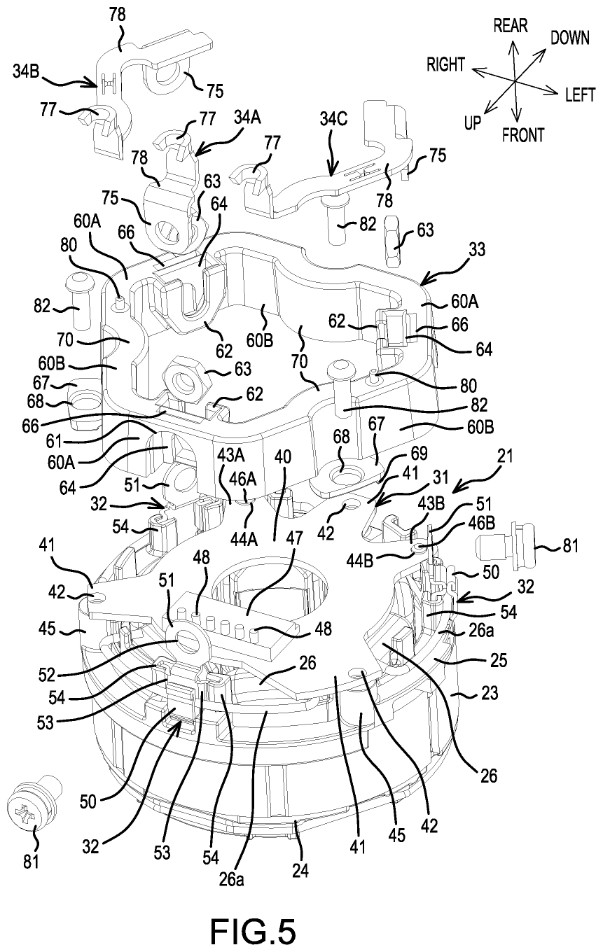

That is, the sensor circuit board 31 will first be further described with reference to FIGS. 2-5. Three fixing pieces 41 each have a through hole 42 in its tip and are provided such that they protrude radially outward and are substantially equi spaced in the radial direction (around the circumference) of the stator 21. The three fixing pieces 41 are provided on a disc part 40, whose diameter is smaller than the inner diameter of the stator core 23. Two positioning pieces 43A, 43B, which each have a through hole 44A, 44B in its tip, are respectively located leftward and rightward of the lower-side fixing piece 41 (i.e. the bottom-most fixing piece 41 of the three fixing pieces 41 according to the directional arrows in FIG. 5). The three fixing pieces 41 respectively correspond to three screw bosses 45, which project rearwardly from the rear insulator 25. The two positioning pieces 43A, 43B respectively correspond to two positioning pins 46A, 46B, which protrude rearwardly from the rear insulator 25 and have differently sized outer diameters. Therefore, the sizes of the through holes 44A, 44B of the positioning pieces 43A, 43B also differ in a corresponding manner. A signal-line connection part 47 is provided on a rear surface of the disc part 40. Signal lines 48 that output the detection signals of the rotation-detection devices are electrically connected on the rearward side of the signal-line connection part 47.

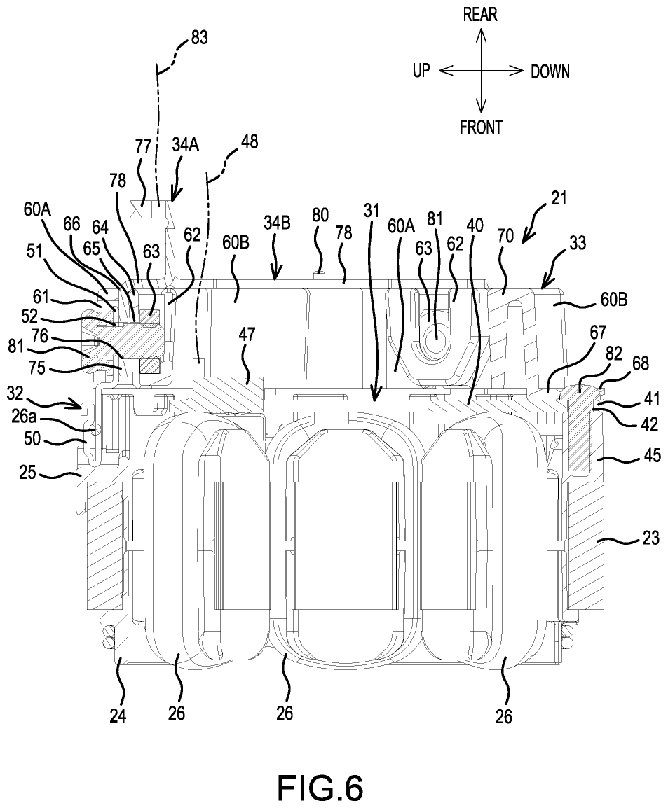

Next, as shown best in FIG. 6, each fusing terminal 32 is formed by bending a strip-shaped sheet metal to have a folded piece 50 on the front end and a connecting piece 51 on the rear end. A through hole 52 is formed in the connecting piece 51. As can be seen in FIGS. 3-5, two projections 53 are formed between the folded piece 50 and the connecting piece 51. Three pairs of retaining parts 54 project rearward from the rear insulator 25 and respectively hold the projections 53 of each the three fusing terminals 32. The three screw bosses 45 are respectively disposed between the three pairs of retaining parts 54 in the circumferential direction of the rear insulator 25.

Each of the fusing terminals 32 is assembled to (mounted on) the rear insulator 25 by inserting the projections 53 into the respective retaining parts 54 with an attitude such that the corresponding folded piece 50 faces radially outward of the stator 21. In this mounted state, each of the connecting pieces 51 protrudes rearward along the axial direction of the stator 21. Furthermore, the magnet wire 26a is interposed and fused within each of the folded pieces 50, so that the fusing terminals 32 are electrically connected to the magnet wire 26a. A delta connection, in which three sets of two coils 26 are respectively connected in series, is formed by the fusing terminals 32.

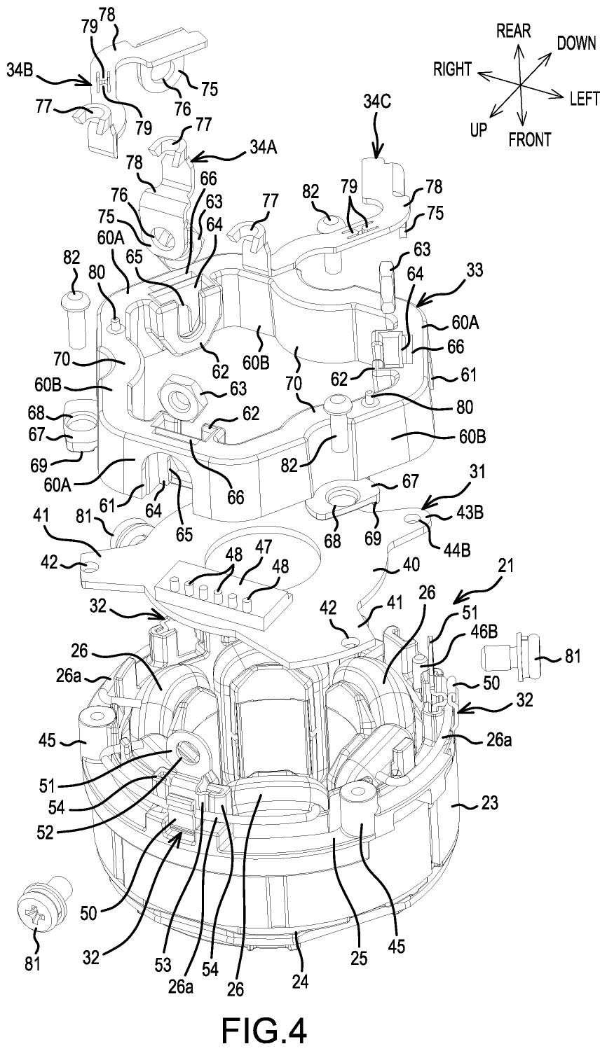

The terminal unit 33 has an endless shape, is made of resin (a polymer-based material), and fits within the inner side of the outer diameter of the stator 21 when viewed from (in) the rear in the axial direction of the stator 21. That is, the outer periphery of the terminal unit 33 is smaller than the outer periphery of the stator 21 and/or a widest diameter (dimension) of the terminal unit 33 in the directions perpendicular to the front-rear direction of the stator 21 (i.e. the radial direction of the stator 21 or rotor 22) is smaller than the outer diameter of the stator core 23. Furthermore, when likewise viewed from the rear, the terminal unit 33 has a generally hexagonal shape and comprises: three straight line parts 60A, which respectively correspond to (are associated with) the three retaining parts 54 of the rear insulator 25, and three straight line parts 60B, which respectively correspond to (are associated with) the three screw bosses 45. A notch 61 is formed (defined) on (in) each of the radially outer surfaces of the straight line parts 60A, and the connecting pieces 51 of the fusing terminals 32 respectively mate with the notches 61. Furthermore, nut receivers (nut retainers/holders) 62 for holding nuts 63 are respectively formed on (in) the radially inner surfaces of the straight line parts 60A, as can be seen in FIG. 4. The rear surface and the radially inner side of the nut receivers 62 are open. A partition wall 64 is interposed between each of the pairs of the notches 61 and the nut receivers 62, and a communication hole 65, wherethrough each pair of the notches 61 and the nut receivers 62 communicate, is formed in each of the partition walls 64. A slit 66, which is open to the rear surface of the terminal unit 33 and which communicates with the corresponding (adjacent) notch 61, is formed on the outer side of and parallel to each of the partition walls 64.

In addition, a mount piece 67 projects radially outward from the outer-surface front end of each of the three straight line parts 60B. The three mount pieces 67 each have a through hole 68 and are respectively aligned with the locations of the three screw bosses 45. An engagement part 69, which engages (mates) with a corner portion of the corresponding fixing piece 41 of the sensor circuit board 31, is formed on each of the mount pieces 67. Arcuate circumvent parts 70, which are designed to prevent interference with three screws 82 respectively inserted in the three through holes 68, are respectively formed in the three straight line parts 60B.

As can best be seen in FIGS. 4 and 5, the three terminal fittings 34A-34C are mounted on the rear surface of the terminal unit 33. Each of the terminal fittings 34A-34C comprises: a frontward-facing (forward-projecting) insertion part 75, which has a through hole 76 and is inserted into the slit 66 of the corresponding straight line part 60A; a rearward-projecting clinching (crimping) part 77; and an intermediate portion 78, which connects the insertion part 75 and the clinching (crimping) part 77. The (first) terminal fitting 34A is a relatively short metal fitting and is designed such that, after the insertion part 75 of the first terminal fitting 34A is inserted into the corresponding slit 66 that is located radially outward of the signal-line connection part 47 of the sensor circuit board 31 and the intermediate portion 78 is disposed on (contacts) the inner rear surface of the straight line part 60A, the clinching part 77 projects rearward of the nut receiver 62. The other two (second and third) terminal fittings 34B, 34C are longer metal fittings and are designed such that, after the insertion parts 75 thereof are inserted into the corresponding slits 66 of the remaining two straight line parts 60A and the intermediate portions 78 extend to the vicinity of (toward) the first terminal fitting 34A along the rear surface of the terminal unit 33, the clinching parts 77 respectively project rearward on the left and right sides of the clinching part 77 of the first terminal fitting 34A. Therefore, the three clinching parts 77 of the terminal fittings 34A-34C are lined up in a straight line in the left-right direction along one of the straight line parts 60A (i.e. the upper-most straight line part 60A), as can be seen in FIG. 3. A pair of latching pieces 79, 79, whose tips face one another, is punched out of the intermediate portion 78 of each of the second and third terminal fittings 34B, 34C. Mating projections 80, which respectively fit between the latching pieces 79 of the second and third terminal fittings 34B, 34C and thereby position the intermediate portions 78 of the second and third terminal fittings 34B, 34C, protrude from the rear surface of the terminal unit 33.

Referring now to FIG. 4, when the sensor circuit board 31 and the terminal unit 33 are to be assembled (joined) to (mounted on) the stator 21 and the magnet wire 26a has been fused to (within) the three fusing terminals 32 respectively held by the three retaining parts 54, the sensor circuit board 31 is set (placed) above the signal-line connection part 47 (while the rear insulator 25 is on the upper side during the assembly), the two through holes 44A, 44B of the positioning pieces 43A, 43B are respectively mated with the two correspondingly-sized positioning pins 46A, 46B, and the three fixing pieces 41 are respectively set (placed) above the three screw bosses 45.

Next, with the nuts 63 being held by (in) the nut receivers 62, the terminal fittings 34A-34C are set (placed) on an upper surface of the terminal unit 33, and the three insertion parts 75 thereof are positioned by being respectively inserted into the three slits 66 of the terminal unit 33. Therefore, the three connecting pieces 51 of the three fusing terminals 32 respectively mate (engage) in the three notches 61 defined in the terminal unit 33. Thereafter, the three mount pieces 67 are respectively placed on (contact) the three fixing pieces 41 and are positioned by the three engagement parts 69. In this assembled state, screws 81 are respectively passed through the notches 61 from the outer side in the radial direction in the order of the through holes 52 of the connecting pieces 51, the communication holes 65 of the partition walls 64, and the through holes 76 of the insertion parts 75, and screwed into the nuts 63 on the inner side. Furthermore, the three screws 82 are respectively screwed, from above (from the rearward direction in FIGS. 2-5), into the three screw bosses 45 through the through holes 68 of the mount pieces 67 and the through holes 42 of the fixing pieces 41. Thus, as shown in FIGS. 2, 3 and 6, the sensor circuit board 31 is fixed to the rear insulator 25 by the screws 82; the terminal unit 33 and the terminal fittings 34A-34C are fixed to the fusing terminals 32 by the screws 81; and the stator 21, which is fixed on (to) the upper side of the sensor circuit board 31, is obtained by virtue of the heads of the screws 82 being respectively mated in the through holes 68 of the mount pieces 67.

Referring now to FIGS. 1 and 2, a front wall 85, which forms a partition between the motor housing 3 and the clutch housing 5, and a rear rib 86, which forms a partition between the motor housing 3 and the grip housing 7, are provided in an inner part of the main-body part 2. The stator 21 is held by the rear rib 86 in a phase (rotational orientation) such that the clinching (crimping) parts 77 of the terminal fittings 34A-34C are on the upper side and held in the front-rear direction at a location at which the axis line (rotational axis) of the stator 21 is eccentric upward relative to the central longitudinal axis of the motor housing 3. Owing to this design, the signal lines 48 connected to the signal-line connection part 47 pass through the terminal unit 33, are drawn (laid) out (extend) rearward from the rear rib 86, pass above the trigger switch 18, and are electrically connected to the control circuit board 16. Power supply lines 83, which are respectively clinched (crimped) in the three clinching parts 77, are also drawn (laid) out (extend) rearward from the stator 21, pass above the trigger switch 18, and are electrically connected to the control circuit board 16.

Thus, because none of the terminal unit 33, the signal lines 48, or the power supply lines 83 is located radially outward of the stator 21, the motor housing 3 surrounding the terminal unit 33, signal lines 48 and power supply lines 83 can be formed narrower, thereby making the screwdriver 1 less wide in the directions perpendicular to the rotational axis of the motor 4 (i.e. in the radial direction of the motor 4).

In addition, it is noted that the rotary shaft 27 of the rotor 22 is rotatably supported in the front-rear direction by a front bearing 88, which is held by a tube-shaped bearing holder 87 received (held) by the front wall 85, and by a rear bearing 89, which is held by the center of the rear rib 86. A centrifugal fan 90 for cooling the motor is secured rearward of the front bearing 88, (not shown) air-suction ports are formed in a region of the motor housing 3 that is radially outward of the stator 21, and (not shown) air-exhaust ports are formed in a region of the motor housing 3 that is radially outward of the centrifugal fan 90.

The rotary shaft 27 passes through the bearing holder 87 and protrudes forward. A pinion 91 (FIG. 2) is secured to the front end of the rotary shaft 27. A speed-reducing mechanism (not shown), which comprises front and rear carriers in two stages that support a plurality of planet gears inside an internal gear, is disposed forward of the bearing holder 87. The pinion 91 meshes with the planet gears of the rear side carrier.

Explanation of Other Main-Body Part Structures

Referring now to FIG. 1, the clutch 6 comprises: a rear cam 95, which rotates integrally with the front-side carrier of the speed-reducing mechanism; and a front cam 97, which engages in the rotational direction with the rear cam 95 via a cam ball 96. A spindle 98 passes through the center of the clutch 6, and the spindle 98 is coupled in the rotational direction to the front cam 97 via balls 100 provided in a cam groove 99. Forward of the front cam 97, a coil spring 102 is provided between a spring bearing 101, through which the spindle 98 passes, and the front cam 97. The front cam 97 is capable of moving forward and rearward relative to the spindle 98 via the balls 100, and is biased toward a retracted position at which the front cam 97 engages with the cam ball 96. The spindle 98 protrudes coaxially into a joint 103, which is provided on a rear end of the front-side housing 10, is held by the front end of the clutch housing 5, and has a small-diameter tube shape. A screw part 104 is formed on a front part of the joint 103 and protrudes forward of the clutch housing 5.

The front-side housing 10 comprises the joint 103 and an elbow 105, which is provided forward of the joint 103 and has the shape of an L turned on its side. A screw sleeve 106 is externally mounted on a rear end of the elbow 105 and is coupled to the clutch housing 5 by being screwed onto an outer circumference of the screw part 104 of the joint 103.

Inside the front-side housing 10, an intermediate shaft 107, which straddles the joint 103 and a rear-end part of the elbow 105 and comprises on its front end a bevel gear 108, is held by a plurality of bearings 109. A hexagonal rear end of the intermediate shaft 107, which projects rearward, mates with a hexagonal hole formed in the front end of the spindle 98 and is coupled integrally in the rotational direction.

In addition, at a downward-facing front-end part of the elbow 105, an output shaft 12 is held by upper and lower bearings 110 and protrudes downward. A bevel gear 111 is provided on the output shaft 12 and meshes with the bevel gear 108 of the intermediate shaft 107.

As a result, when the front-side carrier of the clutch 6, which rotates and reduces the rotational speed of the rotary shaft 27 in two stages, and the rear cam 95 rotate, the front cam 97 rotates via the cam ball 96, and the spindle 98 is caused to rotate via the balls 100 (i.e. owing to the rotational connection (engagement) via the clutch 6). Thus, the intermediate shaft 107, which is integral with the spindle 98, rotates, and the output shaft 12 rotates via the bevel gears 108, 111.

If the load torque transmitted from the output shaft 12 back to the spindle 98 via the intermediate shaft 107 exceeds the pressing force (a set torque) applied to the front cam 97 and determined by the coil spring 102 (e.g., because a screw being driven has been fully screwed (set, fastened) into the workpiece), the front cam 97 advances via the balls 100, which roll in the cam groove 99, and releases its engagement with the cam ball 96, so that the front cam 97 idles relative to the rear cam 95 (i.e. a rotational cutoff or disengagement is performed by the clutch 6 when the load torque exceeds the pre-set torque value so that the output shaft 12 no longer drives the screw).

Downward of the clutch 6, a sensor board 112 is provided that can move in the forward-rearward direction and is biased toward a retracted position by a coil spring 113. An engaging tab 114 protrudes toward the spindle 98 and is positioned forward of the front cam 97. Therefore, when the front cam 97 advances and comes into contact with the engaging tab 114 during the rotational cutoff (disengagement) performed by the clutch 6, the sensor board 112 advances integrally with the front cam 97. A (not shown) magnet is provided on a rear part of the sensor board 112. Downward thereof, a detection board, which has a Hall effect IC on its lower side, is provided in the front-rear direction and is connected to the control circuit board 16 by a (not shown) lead wire. Therefore, when the clutch 6 operates (disengages, idles) and the sensor board 112 has advanced, the change in the magnetic field of the magnet, which has moved forward, is detected by the Hall effect IC, and the detection signal thereof is transmitted by the detection board to the control circuit board 16.

In addition, forward of the sensor board 112, a window, which has a rectangular shape that is elongated in the front-rear direction, is formed on the lower surface of the clutch housing 5. An illumination board 115, which has two illumination lights 116, (LEDs) disposed forward and rearward, is provided inside the window with a tilted attitude such that it is oriented diagonally forward. On the lower side of the illumination board 115, a cover 117, which covers the illumination board 115 from below, is provided and mates, from the inner side, with the window. Therefore, because a lower surface parallel to the illumination board 115 is exposed, the vicinity of the output shaft 12 can be reliably illuminated by the illumination lights 116.

Furthermore, forward of the clutch 6, a notification light-emitting part 118, which is for notifying whether the fastening of the screw is satisfactory, is provided on the front end of the clutch housing 5. The notification light-emitting part 118 comprises: a circuit board 119, on which three notification lights 120 are installed, at spacings (intervals) of 120° in the circumferential direction, along a front surface; and a lens 121, which is mounted forward of the circuit board 119. Two LEDs, one green and one red, are provided in the interior of each of the lights 120.

The lens 121 is formed of a white, translucent resin (polymer), has a ring shape such that its outer diameter is substantially the same as that of the front end of the clutch housing 5, has an outer-circumference rear end that is externally fitted onto a ridge 122 of the clutch housing 5, and is configured to accommodate (hold) the circuit board 119 on its rear surface. On a side (radially outer) surface of the lens 121, a forwardly tapered surface is formed over (around) the entire circumference, and the lights 120 of the circuit board 119 mate with (in) a recessed groove formed in the rear surface of the lens 121.

An O-ring 123 is externally mounted on the joint 103. When the lens 121 has been externally fitted onto a front-end surface of the clutch housing 5, the O-ring 123 comes into contact with the front-surface inner-circumferential side of the lens 121 and thereby retains the lens 121.

Explanation of the Operation of the Screwdriver

In the exemplary screwdriver 1 configured as described above, a driver bit, which is mounted on the output shaft 12, is pressed against a screw to be tightened. In this state, when the trigger 19 is pressed and thereby the trigger switch 18 is turned ON, power is supplied from the battery pack 13 to drive the brushless motor 4. Therefore, the microcontroller of the control circuit board 16 obtains the rotational state of the rotor 22 by acquiring the rotation-detection signals, which were output from the rotation-detection devices of the sensor circuit board 31 and indicate the positions of the permanent magnets 30 of the rotor 22, controls the ON/OFF state of each switching device in accordance with the obtained rotational state, supplies electric current, in order, to (sequentially energize) each of the coils 26 of the stator 21, and thereby rotates the rotor 22. The amount of manipulation (i.e. the press-in amount) of the trigger 19 is transmitted as a signal to the microcontroller, and the rotation of the rotor 22 is controlled in accordance with the manipulation amount.

Thus, when the rotor 22 rotates, the rotary shaft 27 rotates, the carriers rotate at a speed that is reduced by the planet gears, and furthermore the spindle 98, the intermediate shaft 107, and the output shaft 12 rotate via the clutch 6. Thereby, screw tightening by the driver bit becomes possible. As the screw tightening proceeds and the torque set by the coil spring 102 is reached, the front cam 97 advances and, as discussed above, the transmission of rotation from the rear cam 95 to the front cam 97 (and thus to the output shaft 12) is cut off by the clutch 6, so that rotation of the output shaft 12 stops.

At this time, if the detection board detects, while the trigger 19 is being pressed in, that the sensor board 112 has advanced forward due to the operation (rotational disengagement) of the clutch 6 (because the pre-set torque value has been reached), then the microcontroller of the control circuit board 16 determines that the screw tightening is “proper,” and therefore all of the lights 120 of the circuit board 119 in the notification light-emitting part 118 are energized to emit green light. On the other hand, if the detection board does not detect the advance of the sensor board 112 (e.g., because the pressing in of the trigger 19 was stopped prior to the detection of the advance of the sensor board 112), then the microcontroller of the control circuit board 16 determines that the screw tightening is “improper,” and therefore all of the lights 120 of the circuit board 119 are energized to emit red light.

Thus, in the reporting light-emitting part 118, because green or red light is emitted through the entire lens 121 in accordance with the illumination of the three lights 120 that are located immediately on the rear side of the elbow 105, light appears over the front-end surface and around the entire circumference of the front end of the clutch housing 5. Consequently, regardless of the orientation of the screwdriver 1, the user can readily perceive the emission of light from the lens 121 from all directions even without moving the line of sight toward the screw-tightening part (the output shaft 12 and screw) and therefore can easily confirm the determination result regarding the screw fastening operation.

Moreover, in addition to the notifications concerning whether or not the screw tightening was completed properly, the notification light-emitting part 118 may also be configured to provide notifications concerning a drop in the remaining charge of the battery pack 13 (flashing red, etc.), notifications concerning an abnormal drop in the voltage supplied to the controller 15 (red and green turn ON alternatingly, etc.), notifications concerning an abnormal temperature of the controller 15 (flashing red, etc.), or the like.

It is noted that, when the centrifugal fan 90 rotates together with the rotary shaft 27, air sucked in from the air-suction ports cools the brushless motor 4 and is then discharged via the air-exhaust ports.

In addition, when the trigger switch 18 is ON and electrical current is supplied from the control circuit board 16, the illumination lights 116 of the illumination board 115 turn ON. Thereby, the region forward of the driver bit is illuminated through the cover 117, which improves work efficiency, in particular when work is performed in dark places.

Advantages of the Arrangement of the Terminal Fittings

In one aspect of the above-described exemplary embodiment, it is noted that the screwdriver 1 comprises: the stator 21 comprising the tubular stator core 23, the front and rear insulators 24, 25 fixed to the stator core 23, the coils 26 wound through the front and rear insulators 24, 25 and on the stator core 23, and the fusing terminals 32 (coil terminals) connected to the coils 26; the rotor 22, which is capable of rotating relative to the stator 21; and the terminal fittings 34A-34C (lead wire terminals), which are provided integrally with the terminal unit 33 (resin/polymer member) and are connected to the fusing terminals 32, to which the power supply lines 83 (lead wires) are connected. Because the terminal fittings 34A-34C are disposed on the inner side (radially inward) of the outer diameter of the stator core 23 when viewed from (in) the axial direction of the stator core 23, no structure is required to protrude radially outward of the outer circumference of the stator core 23. Therefore, it becomes possible to make the motor housing 3, which houses the stator 21, more compact (narrower) in the radial direction of the stator core 23. In addition, by making the motor housing 3 more compact (narrower) in the radial direction of the stator core 23, when the grip housing 7 is grasped with one hand, the motor housing 3 can be more easily grasped with the other hand, whereby this additional (two hand) grip makes the screwdriver 1 easier to use/manipulate.

Furthermore, because the joining (attachment) of the terminal unit 33 and the sensor circuit board 31 to the stator 21 is released by removing the screws 81, 82, separation of the stator 21 and the controller 15 from one another becomes possible. Therefore, the screwdriver 1 of this embodiment is easy to assemble and disassemble for repair work.

Furthermore, it is noted that the terminal fittings 34A-34C have a rational configuration owing to the fact that, because the terminal fittings 34A-34C are connected to the fusing terminals 32 by the screws 81, the electrical connection between the terminal fittings 34A-34C and the fusing terminals 32 can be achieved simultaneous with their assembly (mounting), thereby simplifying assembly work.

In addition, because the fusing terminals 32 are held by the rear insulator 25, the connecting pieces 51 (connecting parts) of the fusing terminals 32 and the terminal fittings 34A-34C extend in the axial direction of the stator 21, and the fusing terminals 32 are disposed on the inner side (radially inward) of the outer diameter of the stator core 23 when viewed from (in) the axial direction of the stator core 23. Therefore, the fusing terminals 32 also do not jut out (protrude) radially outwardly from the stator core 23 and, moreover, it becomes possible to easily connect the fusing terminals 32 to the terminal fittings 34A-34C using the protruding connecting pieces 51.

Furthermore, because the fusing terminals 32 and the terminal fittings 34A-34C overlap in the radial direction of the stator 21 and are screw fastened, both can be easily screw fastened from (in) the radial direction.

Moreover, because the terminal unit 33 is formed as an endless shape, the terminal fittings 34A-34C can be supported in a stable (robust) manner, and assembly (mounting) of the terminal unit 33 onto the stator 21 also can be performed easily.

It is noted that the configuration of the connecting parts provided on the fusing terminals is not limited to the above-described connecting pieces and they may be configured in a hook shape or as a clinching (crimping) part similar to the clinching parts of the terminal fittings.

The terminal unit may have a shape other than a hexagonal shape in plan view from (in) the axial direction. For example, the terminal unit may have another polygonal shape (e.g., the same number of sides as the number of coils), a circular shape, an oval shape, a mixed angular-curved shape or the like. In addition, the terminal unit is not limited to having an endless shape, and it is also possible to configure the terminal unit as a C shape, a semicircular shape, or the like in plan view. Furthermore, the location, shape, etc. of the terminal fittings is (are) not limited to the location, shape, etc. of the above-described embodiment, and it would not be a problem to arrange them equispaced in the circumferential direction instead of in a straight line, to use an end-part shape other than that of the clinching (crimping) part, etc. It is also possible to form the terminal fittings as inserts in the terminal unit and to make only the end parts of the clinching parts protrude.

Advantages of the Layout of the Power Supply Lines and the Signal Lines

In another aspect of the above-described embodiment, it is noted that the screwdriver 1 comprises: the stator 21 comprising the tubular stator core 23, the front and rear insulators 24, 25 fixed to the stator core 23, the coils 26 wound through the front and rear insulators 24, 25 and on the stator core 23, and the fusing terminals 32 connected to the coils 26; the rotor 22, which is capable of rotating relative to the stator 21; the power supply lines 83, which are indirectly connected to the fusing terminals 32 via the terminal fittings 34A-34C; the sensor circuit board 31, which is fixed to the rear insulator 25; and the signal lines 48, which are connected to the sensor circuit board 31. Because the power supply lines 83 and the signal lines 48 are drawn out (laid out, extend) in the same direction as the axial direction of the stator 21, there is no wiring that juts or protrudes radially outward from the outer circumference of the stator core 23. Therefore, the motor housing 3, which houses the stator 21, can be made (shaped) more compactly (narrower) in the radial direction of the stator core 23.

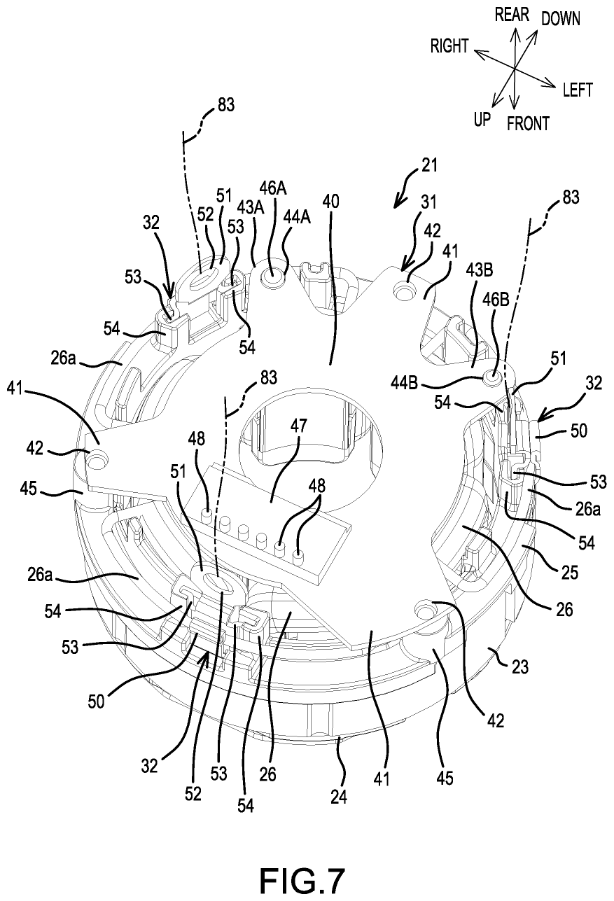

As was mentioned above, in the above-described embodiment, the power supply lines 83 are indirectly connected to the fusing terminals 32 via the terminal fittings 34A-34C of the terminal unit 33. However, in the aspect of the present disclosure in which the power supply lines 83 and the signal lines 48 are drawn (laid) out in the axial direction, the terminal unit and the terminal fittings are not essential. For example, in the modified example shown in FIG. 7, the power supply lines 83 may be directly connected, by soldering, screw fastening, or the like, to the connecting pieces 51 of the fusing terminals 32. In this modified example as well, the power supply lines 83 and the signal lines 48 can be drawn (laid) out of (extend from) the stator 21 in the axial direction of the stator 21. Naturally, the shape of the connecting pieces, the connecting mode (arrangement) to the power supply lines, and the like also can be modified as appropriate.

Advantages of Positioning of the Terminal Unit and the Sensor Circuit Board

In another aspect of the above-described embodiment, it is noted that the screwdriver 1 comprises: the stator 21 comprising the tubular stator core 23, the front and rear insulators 24, 25 fixed to the stator core 23, the coils 26 wound through the front and rear insulators 24, 25 and on the stator core 23, and the fusing terminals 32 connected to the coils 26; the rotor 22, which is capable of rotating relative to the stator 21; the terminal fittings 34A-34C, which are provided integrally with (physically connected to) the terminal unit 33 and are connected to the fusing terminals 32, and to which the power supply lines 83 are connected; and the sensor circuit board 31, which is disposed between the terminal fittings 34A-34C and the stator 21. Because the terminal unit 33, which comprises (holds) the terminal fittings 34A-34C, and the sensor circuit board 31 are positioned (affixed) relative to the stator 21 using the same screws 82, the assembly of the terminal unit 33 and the sensor circuit board 31 can be performed easily. That is, this aspect of the design makes it possible to assemble (mount) the power supply lines 83 onto the stator 21 simply.

In addition, in all of the preceding aspects of the above-described exemplary embodiment, the heads of the screws 82 are mated (set) in the through holes 68 of the mount pieces 67 of the terminal unit 33 and are thereby positioned. However, by making the through holes 68 small, the mount pieces 67, too, may be screw fastened by the screws 82. The number, arrangement, and the like of the screws 81, 82 can also be modified as appropriate. The wiring connection is not limited to the 2-series delta connection of the above-mentioned embodiment and instead may be configured as a 2-parallel delta connection, a 2-series or 2-parallel star (Y) connection, or the like.

In addition, power tools according to the present teachings are not limited to angle screwdrivers. For example, the present teachings are also applicable to other types of power tools, such as angle drills, angle impact drivers, as well as other types of screwdrivers, drills, impact drivers, etc., in which the output shaft does not extend orthogonally to the spindle. Moreover, the main-body part (main housing) is also not limited to being linear (straight). That is, the present teachings are also applicable to so-called T-type (pistol-type) power tools in which the grip housing is coupled orthogonally to the motor housing. The present teachings are even applicable, without limitation, to circular saws, rotary hammers, reciprocating saws, etc.

In addition, the present teachings are not limited to DC (cordless) tools in which a battery pack serves as the power supply. That is, the present teachings are also applicable to AC tools that are powered by a commercial power supply (via a power cord). Finally, there is also no problem with using a motor other than a brushless motor, such as a commutator motor.

Additional embodiments disclosed herein include, but are not limited to:

1. A power tool (1) comprising:

a stator (21) comprising a tubular stator core (23), an insulator (25) fixed to the stator core, a coil (26) wound through the insulator (25) and on the stator core (23), and a coil terminal (32) connected to the coil (26);

a rotor (22) adapted to rotate relative to the stator (21);

a lead wire terminal (34A-34C) physically connected with a polymer member (33) and electrically connected to the coil terminal (32); and

a lead wire (83) electrically connected to the lead wire terminal (34A-34C);

wherein the lead wire terminal (34A-34C) is disposed entirely radially inward of an outer diameter of an outer circumference of the stator core (23) when viewed in an axial direction of the stator core (23).

2. The power tool (1) according to the above-described embodiment 1, wherein the lead wire terminal (34A-34C) is connected to the coil terminal (32) by a screw (81).

3. The power tool (1) according to the above-described embodiment 1 or 2, wherein:
the coil terminal (32) is held by the insulator (25),

a connecting part (51) of the coil terminal (32) and the lead wire terminal (34A-34C) extend in an axial direction of the stator (21), and

the coil terminal (32) is disposed entirely radially inward of the outer diameter of the stator core (23) when viewed in the axial direction of the stator core (23).

4. The power tool (1) according to the above-described embodiment 3, wherein the coil terminal (32) and the lead wire terminal (34A-34C) overlap in a radial direction of the stator and are screw fastened together.

5. The power tool (1) according to any one of the above-described embodiments 1-4, wherein the polymer member (33) has an endless shape.

6. The power tool (1) according to any one of the above-described embodiments 1-5, further comprising:

a sensor circuit board (31) fixed to the insulator (25); and

a signal line (48) electrically connected to the sensor circuit board (31);

wherein the lead wire (83) and the signal line (48) are drawn (laid) out (extend) in the same direction as the axial direction of the stator (21).

7. The power tool (1) according to the above-described embodiment 6, wherein the polymer member (33) and the sensor circuit board (31) are connected to the stator (21) by the same screw (82).

8. The power tool (1) according to the above-described embodiment 6 or 7, wherein the sensor circuit board (31) is disposed between the polymer member (33) and the stator (21).

9. The power tool (1) according to any one of the above-described embodiments 1-8, wherein:

the stator (21) comprises a plurality of coils (26),

the polymer member (33) is a terminal unit having a polygonal shape with a hollow interior and

the number of sides of the polygonal shape of the terminal unit equals the number of coils.

10. The power tool (1) according to any one of the above-described embodiments 1-9, wherein the lead wire terminal (34A-34C) has a crimping part (77) that crimps and electrically connects to the lead wire (83), which is a power supply line for supplying energizing current to the coil (26).

11. The power tool (1) according to any one of the above-described embodiments 1-10, wherein:

the stator (21) comprises six coils (26),

three coil terminals (32) are connected to the coils (26) such that each one of the coil terminals is respectively connected to two of the six coils,

three lead wire terminals (34A-34C) are physically connected with the polymer member (33) and are respectively electrically connected to the three coil terminals (32);

three lead wires (83) are respectively electrically connected to the three lead wire terminals (34A-34C); and

the three lead wire terminals (34A-34C) are disposed entirely radially inward of the outer diameter of the stator core (23) when viewed in the axial direction of the stator core (23).

12. The power tool (1) according to any one of the above-described embodiments 1-11, further comprising:

a motor housing (3) holding the stator (21) and rotor (22);

a grip housing (7) connected to the motor housing and having a trigger (19);

a battery mount part (8) connected to the grip housing (7); and

a control circuit board (16) disposed in the battery mount part (8);

wherein the motor housing (3), the grip housing (7) and battery mount part (8) extend linearly, and

the lead wire(s) (83) extend(s) from a rear side of the motor housing (3) through the grip housing (7) to the control circuit board (16) such that the lead wire(s) (83) never protrude(s) radially outwardly of the outer diameter of the stator core (23) between the lead wire terminal(s) (34A-34C) and the control circuit board (16), to which the lead wire(s) (83) is/are electrically connected.

13. A power tool comprising:

a stator (21) comprising a tubular stator core (23), an insulator (25) fixed to the stator core (23), a coil (26) wound through the insulator and on the stator core (23), and a coil terminal (32) connected to the coil (26);

a rotor (22) adapted to rotate relative to the stator (21);

a power supply line (83), which is directly or indirectly electrically connected to the coil terminal (32);

a sensor circuit board (31) fixed to the insulator (25); and

a signal line (48) electrically connected to the sensor circuit board (31);

wherein the power supply line (83) and the signal line (48) are drawn (laid) out (extend) in the same direction as the axial direction of the stator (21).

14. The power tool (1) according to the above-described embodiment 13, further comprising:

a lead wire terminal (34A-34C) physically connected with a polymer member (33) and electrically connected to the coil terminal (32);

wherein the lead wire (83) is electrically connected to the lead wire terminal (34A-34C).

15. The power tool (1) according to the above-described embodiment 14, wherein the polymer member (33) is connected to the coil terminal (32) by a screw (81).

16. The power tool (1) according to the above-described embodiment 14 or 15, wherein:

the coil terminal (32) is held by the insulator (25), and

a connecting part (51) of the coil terminal (32) and the lead wire terminal (34A-34C) extend in an axial direction of the stator (21).

17. The power tool (1) according to any one of the above-described embodiments 14-16, wherein the coil terminal (32) and the lead wire terminal (34A-34C) overlap in a radial direction of the stator (21) and are screw fastened together.

18. The power tool (1) according to any one of the above-described embodiments 14-17, wherein the polymer member (33) has an endless shape.

19. The power tool (1) according to any one of the above-described embodiments 14-18, wherein the polymer member (33) and the sensor circuit board (31) are connected to the stator (21) by the same screw (82).

20. The power tool (1) according to any one of the above-described embodiments 14-19, wherein the sensor circuit board (31) is disposed between the polymer member (33) and the stator (21).

21. The power tool (1) according to any one of the above-described embodiments 14-20, wherein:

the stator (21) comprises a plurality of coils (26),

the polymer member (33) is a terminal unit having a polygonal shape with a hollow interior and

the number of sides of the polygonal shape of the terminal unit (33) equals the number of coils (26).

22. The power tool (1) according to any one of the above-described embodiments 14-21, wherein the lead wire terminal (34A-34C) has a crimping part (77) that crimps and electrically connects to the lead wire (83), which is a power supply line for supplying energizing current to the coil (26).

23. The power tool (1) according to any one of the above-described embodiments 14-22, wherein:

the stator (21) comprises six coils (26),

three coil terminals (32) are connected to the coils (26) such that each one of the coil terminals is respectively connected to two of the six coils,

three lead wire terminals (34A-34C) are physically connected with the polymer member (33) and are respectively electrically connected to the three coil terminals (32),

three lead wires (83) are respectively electrically connected to the three lead wire terminals (34A-34C), and

the three lead wire terminals (34A-34C) are disposed entirely radially inward of an outer diameter of the outer circumference the stator core (23) when viewed in the axial direction of the stator core (23).

24. The power tool (1) according to any one of the above-described embodiments 14-23, further comprising:

a motor housing (3) holding the stator (21) and rotor (22);

a grip housing (7) connected to the motor housing and having a trigger (19);

a battery mount part (8) connected to the grip housing (7); and

a control circuit board (16) disposed in the battery mount part (8);

wherein the motor housing (3), the grip housing (7) and battery mount part (8) extend linearly, and

the signal line (48) extends from a rear side of the motor housing (3) through the grip housing (7) to the control circuit board (16) such that the signal line (48) never protrudes radially outwardly of the outer diameter of the outer circumference of the stator core (23) between the sensor circuit board (31) and the control circuit board (16), to which the signal line (48) is electrically connected.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved power tools.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EXPLANATION OF THE REFERENCE NUMBERS

1 Rechargeable (cordless) angle screwdriver
2 Main-body part (housing)
3 Motor housing
4 Brushless motor
5 Clutch housing
6 Clutch
7 Grip housing
8 Battery-mount part
10 Front-side housing
11 Output part
12 Output shaft
13 Battery pack
15 Controller
16 Control circuit board
21 Stator
22 Rotor
24 Front insulator
25 Rear insulator
26 Coil
27 Rotary shaft
31 Sensor circuit board
32 Fusing terminal (coil terminal)
33 Terminal unit (resin/polymer member)
34A-34C Terminal fittings
40 Disc part
41 Fixing piece
45 Screw boss
47 Signal-line connection part
48 Signal line
50 Folded piece
51 Connecting piece
60A, 60B Straight line parts
61 Notch
62 Nut receiver
63 Nut
67 Mount piece
75 Insertion part
77 Clinching (crimping) part
81, 82 Screws
83 Power supply line (lead wire)
98 Spindle

I claim:

1. A power tool comprising:
a stator comprising a tubular stator core, an insulator fixed to the stator core, a coil wound through the insulator and on the stator core, and a coil terminal connected to the coil;
a rotor configured to rotate relative to the stator;
a lead wire terminal physically connected to a polymer member and electrically connected to the coil terminal; and
a lead wire electrically connected to the lead wire terminal;
wherein the lead wire terminal is disposed entirely radially inward of an outer diameter of an outer circumference of the stator core when viewed in an axial direction of the stator core.

2. The power tool according to claim 1, wherein the lead wire terminal is connected to the coil terminal by a screw.

3. The power tool according to claim 1, wherein:
the coil terminal is held by the insulator,
the lead wire terminal and a connecting part of the coil terminal are in, or in parallel to, the axial direction of the stator core, and
the coil terminal is disposed entirely radially inward of the outer diameter of the outer circumference of the stator core when viewed in the axial direction of the stator core.

4. The power tool according to claim 3, wherein the coil terminal and the lead wire terminal overlap in a radial direction of the stator and are screw fastened together.

5. The power tool according to claim 1, wherein the polymer member has an endless shape.

6. The power tool according to claim 1, further comprising:
a sensor circuit board fixed to the insulator; and
a signal line electrically connected to the sensor circuit board;
wherein the lead wire and the signal line extend in the same direction as the axial direction of the stator.

7. The power tool according to claim 6, wherein the polymer member and the sensor circuit board are connected to the stator by the same screw.

8. The power tool according to claim 6, wherein the sensor circuit board is disposed between the polymer member and the stator.

9. The power tool according to claim 1, wherein:
the stator comprises a plurality of coils,
the polymer member is a terminal unit having a polygonal shape with a hollow interior, and
the number of sides of the polygonal shape of the terminal unit equals the number of coils.

10. The power tool according to claim 1, wherein:
the lead wire terminal has a crimping part that crimps and electrically connects to the lead wire, and
the lead wire is a power supply line that supplies energizing current to the coil.

11. The power tool according to claim 1, wherein:
the stator comprises six coils,
three coil terminals are connected to the coils such that each one of the coil terminals is respectively connected to two of the six coils,
three lead wire terminals are physically connected to the polymer member and are respectively electrically connected to the three coil terminals,
three lead wires are respectively electrically connected to the three lead wire terminals, and
the three lead wire terminals are disposed entirely radially inward of the outer diameter of the outer circumference of the stator core when viewed in the axial direction of the stator core.

12. The power tool according to claim 1, further comprising:
a motor housing holding the stator and the rotor;
a grip housing connected to the motor housing and having a trigger;
a battery mount part connected to the grip housing; and
a control circuit board disposed in the battery mount part;
wherein:
the motor housing, the grip housing, and the battery mount part extend linearly, and
the lead wire extends from a rear side of the motor housing through the grip housing to the control circuit board such that the lead wire never protrudes radially outwardly of the outer circumference of the stator core between the lead wire terminal and the control circuit board, to which the lead wire is electrically connected.

13. The power tool according to claim 4, further comprising:
a motor housing holding the stator and the rotor;
a grip housing connected to the motor housing and having a trigger;
a battery mount part connected to the grip housing; and
a control circuit board disposed in the battery mount part;
wherein the motor housing, the grip housing, and the battery mount part extend linearly, and
the lead wire extends from a rear side of the motor housing through the grip housing to the control circuit board such that the lead wire never protrudes radially outwardly of the outer circumference of the stator core between the lead wire terminal and the control circuit board, to which the lead wire is electrically connected.

14. The power tool according to claim 13, further comprising:
a sensor circuit board fixed to the insulator; and
a signal line electrically connected to the sensor circuit board;
wherein:
the lead wire and the signal line extend in the same direction as the axial direction of the stator core, and
the signal wire never protrudes radially outwardly of the outer circumference of the stator core between the sensor circuit board and the control circuit board.

15. The power tool according to claim 14, wherein:
the polymer member and the sensor circuit board are connected to the stator by the same screw,
the sensor circuit board is disposed between the polymer member and the stator, and
the polymer member has an endless shape.

16. The power tool according to claim 15, wherein:
the stator comprises a plurality of coils,
the polymer member is a terminal unit having a polygonal shape with a hollow interior, and
the number of sides of the polygonal shape of the terminal unit equals the number of coils.

17. The power tool according to claim 16, wherein:
the lead wire terminal has a crimping part that crimps and electrically connects to the lead wire, and
the lead wire is a power supply line that supplies energizing current to the coil.

18. The power tool according to claim 17, wherein:
the stator comprises six coils,
three coil terminals are connected to the coils such that each one of the coil terminals is respectively connected to two of the six coils,
three lead wire terminals are physically connected to the polymer member and are respectively electrically connected to the three coil terminals,
three lead wires are respectively electrically connected to the three lead wire terminals, and
the three lead wire terminals are disposed entirely radially inward of the outer diameter of the outer circumference of the stator core when viewed in the axial direction of the stator core.

19. A power tool comprising:
a stator comprising a tubular stator core, an insulator fixed to the stator core, a coil wound through the insulator and on the stator core, and a coil terminal connected to the coil;
a rotor configured to rotate relative to the stator and having a rotary shaft extending in an axial direction;
a power supply line directly or indirectly electrically connected to the coil terminal;
a sensor circuit board fixed to the insulator; and
a signal line electrically connected to the sensor circuit board;
wherein the power supply line and the signal line extend in parallel to the axial direction.

20. The power tool according to claim 19, further comprising:
a motor housing holding the stator and the rotor;
a grip housing connected to the motor housing and having a trigger;
a battery mount part connected to the grip housing; and
a control circuit board disposed in the battery mount part;
wherein:
the motor housing, the grip housing, and the battery mount part extend linearly, and
the power supply line and the signal line extend from a rear side of the motor housing through the grip housing to the control circuit board such that neither the power supply line nor the signal line protrudes radially outwardly of an outer diameter of an outer circumference of the stator core between the motor housing and the control circuit board.
